(19) United States
(12) Patent Application Publication
(10) Pub. No.: US 2024/0351880 A1
(43) Pub. Date: Oct. 24, 2024

(54) METHOD FOR PREPARING SINGLE-WALLED CARBON NANOTUBES USING SINGEL-ATOM CATALYST, AND SINGLE-WALLED CARBON NANOTUBES PREPARED THEREBY

(71) Applicant: KOREA INSTITUTE OF ENERGY RESEARCH, Daejeon (KR)

(72) Inventors: Hee-yeon KIM, Daejeon (KR); Cha-heon KIM, Seosan-si (KR); So Jung KIM, Sejong-si (KR)

(73) Assignee: KOREA INSTITUTE OF ENERGY RESEARCH, Daejeon (KR)

(21) Appl. No.: 18/631,580

(22) Filed: Apr. 10, 2024

(30) Foreign Application Priority Data
Apr. 21, 2023 (KR) 10-2023-0052947

(51) Int. Cl. C01B 32/162; B01J 21/04; B01J 23/755; B01J 35/30; B01J 37/02; B01J 37/18; B82Y 30/00; B82Y 40/00; C01B 32/159; H01M 4/62

(52) U.S. Cl. CPC C01B 32/162; B01J 21/04; B01J 23/755; B01J 35/393; B01J 37/0221; B01J 37/18; C01B 32/159; H01M 4/625; B82Y 30/00; B82Y 40/00; C01B 2202/02; C01B 2202/22; C01B 2202/36; C01P 2004/01

(57) ABSTRACT

Provided is a method for preparing single-walled carbon nanotubes (SWCNTs), including the steps of: (a) depositing a metal catalyst in the form of single atom or atomic cluster on a catalyst support to prepare a single-atom catalyst or an atomic cluster catalyst; and (b) growing carbon nanotubes on the single-atom catalyst or the atomic cluster catalyst to prepare single-walled carbon nanotubes (SWCNTs). According to the method, it is possible to uniformly mass-produce single-walled carbon nanotubes (SWCNTs) having excellent heat conductivity, electroconductivity, mechanical strength, dispersibility, or the like.

### CROSS-REFERENCE TO RELATED APPLICATION

This application claims priority to Korean Patent Application No. 10-2023-0052947 filed on Apr. 21, 2023, and all the benefits accruing therefrom under 35 U.S.C. § 119, the contents of which in its entirety are herein incorporated by reference.

### BACKGROUND

### 1. Field

The present disclosure relates to a method for preparing single-walled carbon nanotubes and single-walled carbon nanotubes prepared thereby. Particularly, the present disclosure relates to a method for preparing single-walled carbon nanotubes using a single-atom or atomic cluster catalyst, and single-walled carbon nanotubes prepared thereby.

### 2. Description of the Related Art

A single-walled carbon nanotube is a molecular chain in which graphite sheets having six carbon atoms forming a hexagon are linked in a tubular shape. Carbon nanotubes show a strength approximately 100 times higher than the strength of iron and have a high electroconductivity similar to the electroconductivity of copper. Since carbon nanotubes have excellent heat conductivity and a curled molecular chain, they also show physical properties of metal or semiconductor. By virtue of the above-mentioned characteristics, carbon nanotubes are frequently used as additives for improving performance in various fields, including batteries, semiconductors, ceramics, paints, coating, films, or the like. However, it has been regarded as a long-standing conundrum in the science and technology world to mass-produce carbon nanotubes having a uniform shape. Moreover, since industrial application of carbon nanotubes is insignificant as compared to the facility investment and research and development expenditure for synthesizing carbon nanotubes, the development of carbon nanotubes is quite slow despite the history of research and development for about 30 years or more.

Recently, while researchers have focused their attention on improving the performance and durability of electrodes with the remarkable growth of the battery industry, it is known that carbon nanotubes are useful as electrode materials, and a domestic major company is mass-producing carbon nanotubes for a battery. However, it is important to synthesize single-walled carbon nanotubes having only one wall, not multi-walled carbon nanotubes having multiple walls, in order to maximize the performance by substituting amorphous carbon used conventionally as an electrode material for a secondary battery with carbon nanotubes, but the mass production technology of single-walled carbon nanotubes is at a rudimentary level worldwide.

Various methods for synthesizing carbon nanotubes have been developed and used. The electric discharge method is a method used frequently in the early stage of carbon nanotube synthesis, wherein carbon nanotubes are synthesized when carbon clusters released from a graphite rod used as a positive electrode upon discharge are condensed on a negative electrode graphite rod maintaining a low temperature. The method is favorable to the synthesis of carbon nanotubes having high crystallinity, but there is a disadvantage in that a large amount of impurities are contained during the synthesis and the production cost is high, which makes it difficult to apply the product to the market. In addition, the laser deposition method uses the principle that graphite is vaporized by irradiating laser to a graphite target in a hot oven and the vaporized graphite is condensed on a cold collector. The laser deposition method is frequently used to synthesize carbon nanotubes agglomerated in the form of bundles and is favorable to the synthesis of carbon nanotubes having high crystallinity. Meanwhile, the plasma enhanced chemical vapor deposition (PECVD) method is advantageous in that carbon nanotubes can be synthesized at a low temperature of 500° C. or lower, and is characterized in that a bamboo-like joint is formed in the middle of the synthesized carbon nanotubes. Therefore, the method is disadvantageous in that the carbon nanotubes have lower crystallinity as compared to the carbon nanotubes synthesized through the thermal chemical vapor deposition method. In addition, the thermal chemical vapor deposition (thermal CVD) method includes depositing a metal, such as iron, cobalt or nickel, and growing carbon nanotubes by using the metal as a seed. Herein, the growth characteristics and shape of carbon nanotubes vary depending on the size and properties of metal particles, and thus optimization of the particle size and shape is important. Conventionally, a method including depositing a metal, such as iron, cobalt or nickel, on a substrate, and treating the substrate with HF to form small metal particles has been used. However, since the size and shape of carbon nanotubes vary with the particle size, the method for forming particles is important. The method is advantageous in that it provides and uses various products and starting materials, is suitable for the synthesis of a high-purity material and can control the microstructure. Further, the vapor phase growth method includes synthesizing carbon nanotubes while introducing catalyst particles and reactant gases continuously into a reactor. The method uses ethylene (C₂H₄), carbon monoxide (CO), methane (CH₄), acetylene (C₂H₂), benzene, xylene, or the like, as reactant gases, and carbon nanotubes are synthesized while a catalyst-containing organic compound, such as Fe(CO)₅ or Fe(C₅H₅)₂, is introduced simultaneously with the reactant gases. In this method, the size and structure of carbon nanotubes are determined depending on the size of decomposed metal catalyst particles.

Therefore, it is an important factor of determining the quality of carbon nanotubes to control the particle size of the metal catalyst.

### REFERENCES

### Patent Documents

Korean Patent Publication No. 10-2182553
Korean Patent Laid-Open No. 10-2010-0119377

### SUMMARY

The present disclosure is directed to providing a method for preparing single-walled carbon nanotubes (SWCNTs) which provides single-walled carbon nanotubes (SWCNTs) having excellent heat conductivity, electroconductivity, mechanical strength and dispersibility and particularly allows mass production of SWCNT having a diameter of less than 3 nm by reducing the size of catalyst particles functioning as seeds in a process for preparing carbon nanotubes to a single-atom scale, and single-walled carbon nanotubes (SWCNTs) obtained thereby.

In one aspect, there is provided a method for preparing single-walled carbon nanotubes (SWCNTs), including the steps of:
(a) depositing a metal catalyst in the form of single atom or atomic cluster on a catalyst support to prepare a single-atom catalyst or an atomic cluster catalyst; and
(b) growing carbon nanotubes on the single-atom catalyst or the atomic cluster catalyst to prepare single-walled carbon nanotubes (SWCNTs).

Step (a) may include the steps of:
(a-1) introducing a catalyst precursor to a vaporizer cut off from outside air, supplying an inert gas thereto and warming the vaporizer;
(a-2) introducing a catalyst support to a reactor, supplying an inert gas thereto and warming the reactor; and
(a-3) opening a path through which the vaporizer is linked with the reactor after completing the warming in steps (a-1) and (a-2) to vaporize the catalyst precursor and to carry out chemical vapor deposition on the catalyst support in the reactor.

In step (a-1), the catalyst precursor may be a catalyst precursor including any one selected from nickel (Ni), cobalt (Co), iron (Fe), platinum (Pt), gold (Au), aluminum (Al), chromium (Cr), copper (Cu), magnesium (Mg), manganese (Mn), molybdenum (Mo), rhodium (Rh), silicon (Si), tantalum (Ta), titanium (Ti), tungsten (W), uranium (U), vanadium (V) and zirconium (Zr).

In step (a-2), the catalyst precursor is a nickel (Ni)-containing catalyst precursor, and the reactor may be warmed to a temperature of 150-500° C.

In step (a-3), the catalyst precursor may further supply oxygen (O₂) or hydrogen (H₂) gas as a reactant gas accelerating the deposition on the surface of the catalyst support.

Step (b) may include the steps of:
(b-1) disposing the single-atom catalyst or the atomic cluster catalyst in the reactor and carrying out reduction of the catalyst; and
(b-2) supplying an inert gas to the reactor, warming the reactor to 700-1000° C., and introducing a hydrocarbon gas to grow single-walled carbon nanotubes (SWCNTs).

In step (b-1), the reduction may be carried out by supplying hydrogen gas and an inert gas.

In step (b-1), the reduction may be carried out at 300-500° C.

In step (b-2), the hydrocarbon gas may be any one selected from methane (CH₄), acetylene, ethylene, propane, methanol, ethanol, propanol, butanol, acetone, benzene, xylene, hexane, dimethyl ether, pyridine, ethyl acetate, diethyl ether, polyethylene glycol and dichloromethane.

In step (b-2), the hydrocarbon gas may be supplied at a concentration of 1-10 vol %.

The catalyst support may be any one selected from a ceramic support, a carbonaceous support and a metal support.

The ceramic support may be any one selected from alumina, silica, titania, zirconia, magnesia, silicon carbide, tungsten carbide and silicon nitride.

The carbonaceous support may be any one selected from graphite, carbon black, acetylene black, denka black, ketjen black, activated carbon, mesoporous carbon, carbon nanotubes, carbon nanofibers, carbon nanohorns, carbon nanorings, carbon nanowires, pullerene and Super P.

The method for preparing single-walled carbon nanotubes (SWCNTs) may be for preparing single-walled carbon nanotubes (SWCNTs) having a sectional diameter of 0.3-3 nm.

Preferably, the method for preparing single-walled carbon nanotubes (SWCNTs) may be for preparing single-walled carbon nanotubes (SWCNTs) having a sectional diameter of 0.3-1.5 nm by using a single-atom catalyst.

Preferably, the method for preparing the method for preparing single-walled carbon nanotubes (SWCNTs) may be for preparing single-walled carbon nanotubes (SWCNT) having a sectional diameter of 1.5-3 nm by using an atomic cluster catalyst.

In another aspect, there are provided single-walled carbon nanotubes (SWCNTs) prepared by the method for preparing single-walled carbon nanotubes (SWCNTs).

In still another aspect, there is provided an electrode for a secondary battery including the single-walled carbon nanotubes (SWCNTs).

The method for preparing single-walled carbon nanotubes (SWCNTs) according to the present disclosure includes highly dispersing and synthesizing catalyst particles in a single-atom scale, and thus can provide significantly thin single walled carbon nanotubes having a well-controlled shape as compared to carbon nanotubes prepared by using conventional catalyst nanoparticles as seeds. In addition, a vapor phase process capable of being operated at low temperature is applied to synthesize the single atom, and thus the method can accurately control a path through which a catalyst precursor is deposited on the surface of a support. Further, since atoms are deposited in a form directly bound to a functional group or defect of the surface, they are not agglomerated by external factors, such as heating, and can retain a highly dispersed state, which is significantly effective for preparing single-walled carbon nanotubes.

Additionally, the single-walled carbon nanotubes obtained by using, as a seed, the single-atom catalyst or the atomic cluster catalyst prepared from the method for preparing single-walled carbon nanotubes (SWCNTs) according to the present disclosure have a uniform shape and show excellent physical and chemical properties, including electroconductivity, heat conductivity, mechanical strength, crystallinity, or the like.

### BRIEF DESCRIPTION OF THE DRAWINGS

FIG. 1 is a schematic view illustrating the single-walled carbon nanotubes (SWCNTs) using a single-atom or atomic cluster catalyst as a seed according to the present disclosure.

FIG. 2 is a schematic view illustrating the single-walled carbon nanotubes (SWCNTs) using a conventional nano-scaled catalyst as a seed.

FIG. 3 shows the results of determining a change in weight of the nickel catalyst precursor depending on temperature according to Test Example 1.

FIG. 4 is an electron microscopic image illustrating the single-atom nickel catalyst deposited on an alumina support prepared according to (1) of Example 1 in Test Example 2.

FIG. 5 is an electron microscopic image illustrating the atomic cluster form of nickel catalyst prepared according to (1) of Example 1 in Test Example 2.

FIG. 6 is an electron microscopic image illustrating the single-walled carbon nanotubes (SWCNTs) prepared according to Example 1 of Test Example 3.

FIG. 7 is an electron microscopic image illustrating the single-walled carbon nanotubes (SWCNTs) prepared according to Comparative Example 1 of Test Example 3.

FIG. 8 shows the results of X-ray diffractometry of Test Example 5.

### DETAILED DESCRIPTION

Hereinafter, various aspects and embodiments of the present disclosure will be explained in more detail.

Exemplary embodiments now will be described more fully hereinafter with reference to the accompanying drawings, in which exemplary embodiments are shown.

However, such exemplary embodiments are for illustrative purposes only, and the present disclosure should not be construed as limited to the exemplary embodiments set forth therein. In the description, details of well-known features and techniques may be omitted to avoid unnecessarily obscuring the technical gist of the present disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be understood that the terms “comprises” and/or “comprising”, or “includes” and/or “including” when used in this specification, specify the presence of stated features, numbers, steps, operations, elements, or combinations thereof, but do not preclude the presence or addition of one or more other features, numbers, steps, operations, elements, or combinations thereof.

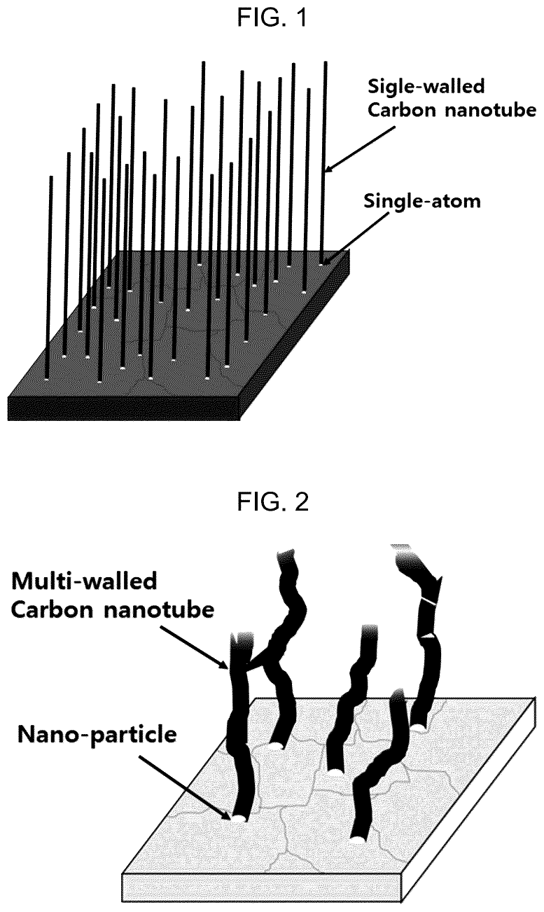

FIG. 1 is a schematic view illustrating the single-walled carbon nanotubes (SWCNTs) using, as a seed, a single-atom or atomic cluster catalyst according to the present disclosure, and FIG. 2 is a schematic view illustrating the single-walled carbon nanotubes (SWCNTs) using a conventional nano-scaled catalyst as a seed.

Hereinafter, the method for preparing single-walled carbon nanotubes according to the present disclosure will be explained with reference to FIG. 1 and FIG. 2.

First, a metal catalyst is deposited on a catalyst support in the form of a single atom or atomic cluster to prepare a single-atom catalyst or an atomic cluster catalyst (step a).

Particularly, this step is carried out preferably by the following method.

First, the catalyst support is introduced to a vaporizer cut off from outside air, an inert gas is supplied thereto, and the vaporizer is warmed (step a-1).

The catalyst precursor may be a precursor of any one metal catalyst selected from nickel (Ni), cobalt (Co), iron (Fe), platinum (Pt), gold (Au), aluminum (Al), chromium (Cr), copper (Cu), magnesium (Mg), manganese (Mn), molybdenum (Mo), rhodium (Rh), silicon (Si), tantalum (Ta), titanium (Ti), tungsten (W), uranium (U), vanadium (V) and zirconium (Zr), and preferably, may be a precursor of any one metal catalyst selected from nickel (Ni), cobalt (Co) and iron (Fe).

The nickel (Ni)-containing catalyst precursor may be at least one selected from nickel(II) bis(2,2,6,6-tetramethyl-3,5-heptanedionate), nickel(II) chloride, nickel(II) acetylacetonate, bis(methylcyclopentadienyl)nickel, nickel tetracarbonyl, nickel bis(dimethylglyoximate), nickel tetramethyl heptanedionate, N,N′-ethylenebis(2,4-pentanedion-iminoato)nickel(II), nickel bis(2-amino-pent-2-en-onato), nickelocene, bis(1,4-di-isopropyl-1,3-diazabutadienyl)nickel, bis-(ethylcyclopentadienyl) nickel, cyclopentadienylallylnickel, (tetramethylethylenediamine) nickel bis(acetylacetonate), allylalkylpyrrolylimino nickel(II), bis(N,N′-di-tertbutylacetamidinato) nickel(II), (η3-cyclohexenyl)(η5-cyclopentadienyl)nickel(II), tetracarbonyl nickel, bis(1,4-di-t-butyl-1,3-diazabutadienyl) nickel(II), bis(1,2-diphenylethanedionedioximato) nickel(II), 1-diethylamino-2-methyl-2-propanolate) nickel, (1-diethylamino2-methyl-2-propanolate) nickel, bis(3,4-hexanedionedioximato) nickel(II), nickel(II) 1-dimethylamino-2-methyl-2-butoxide, (dimethylamino-2-propoxide) nickel, bis(1,4-diisopropyl-1,4-diazabutadiene) nickel, bis(4,5-octanedionedioximato)nickel(II), bis(4-Nethylamino-3-penten-2-N-ethyliminato)nickel(II), bis(ethanedialdioximato) nickel(II), (1,1,1,5,5,5-hexafluoroacetylacetonate) nickel, bis(2-imino-penen-4-trifluoro-acetylacetonato) nickel, bis(2,3-pentanedionedioximato) nickel(II), bis(1,2-cyclohexanedionedioximato) nickel(II), bis(N,N′-ditertialbutylacetamidinate) nickel, bis(1,4-di-tert-butyl-diaza-1,3-butadiene) nickel, bis(N,N′-di-tert-butylacetamidinate) nickel, (2-thenoyltrifluoroacetone)(tetramethylethylenediamine) nickel, (N,N,N′,N′,-tetramethyl-1,3-propanediamine) nickel(II) chloride, bis(pentamethylcyclopentadienyl)nickel(II) and bis(ipropylcyclopentadienyl)nickel.

The cobalt (Co)-containing catalyst precursor may be at least one selected from bis(N-t-butyl-N′-ethylpropanimidamidato)cobalt(II), bis(N,N′-di-i-propylacetamidinato)cobalt(II), bis(1,4-di-t-butyl-1,3-diazabutadienyl)cobalt(II), bis(1,4-di-t-butyl-1,3-diazabutadienyl)cobalt(II) Co(DAD)₂, bis(cyclopentadienyl) cobalt(II), cobalt(III) acetylacetonate, cobalt carbonyl, cobalt tricarbonyl nitrosyl, cyclopentadienylcobalt dicarbonyl, (3,3-dimethyl-1-butyne)dicobalt hexacarbonyl, tris(2,2,6,6-tetramethyl-3,5-heptanedionato)cobalt(III), bis(b-diketonato)Co(II), tris(dimethylheptanedionato)cobalt(III), tris(3,5-heptanedionato) cobalt(III), bis(tris(2,6-dimethyl-3,5-heptanedione)Co, (1-phenyl-1,3-butanedione)Co, tris(1,3-diphenyl-1,3-propanedione)Co, bis(thenoyl-trifluoroacetone)(N,N,N,N-tetramethylethylendiamine)Co, cobalt tetracarbonyl hydride, Co(PF₃)4H, and bis(4-(methoxyethylamino)pent-3-en-2-onato) cobalt(II).

The iron (Fe)-containing catalyst precursor may be at least one selected from ferrocene, bis(2,4-dimethylpentadienyl)iron, ferric chloride, bis(N,N′-di-t-butylacetamidinato)iron(II), [Fe(thd)₃], [Fe₂(O^{t}Bu)₆], Fe(acac)₃ and bis(bis(trimethylsilyl)amide) iron(II).

The inert gas may be supplied preferably at 40-60 sccm for 30-60 minutes to remove the internal impurities.

The vaporizer is warmed preferably to a temperature of 150-300° C. When the temperature of the vaporizer is less than the lower limit, vaporization of the catalyst precursor cannot occur actively and the reaction is inhibited. When the temperature of the vaporizer is more than the upper limit, the catalyst precursor is vaporized at an excessively high rate, and thus the interaction of the vaporized catalyst precursor with the support on which the catalyst precursor is to be deposited cannot occur sufficiently. As a result, chemical vapor deposition cannot be performed effectively to cause degradation of the catalyst.

Meanwhile, the catalyst support is introduced to a reactor, an inert gas is supplied thereto, and the reactor is warmed (step a-2).

The temperature of the reactor may vary depending on the type of the catalyst precursor.

For example, when using a nickel (Ni)-containing catalyst support, the reactor may be warmed preferably to a temperature of 150-500° C., more preferably 180-400° C., and most preferably 200-300° C. to deposit a single-atom catalyst. When the temperature of the reactor is higher than the upper limit temperature, 500° C., agglomeration or sintering of the catalyst particles occurs, and thus the catalyst is formed in the form of nanoparticles or microparticles rather than the form of a single-atom catalyst. In this case, single-walled carbon nanotubes cannot be prepared well, and multi-walled carbon nanotubes are prepared or chunk-like carbon deposits are formed. Meanwhile, when the temperature of the reactor is lower than the lower limit temperature, 150° C., the vapor-phase nickel (Ni)-containing catalyst precursor cannot be deposited sufficiently on the surface of a support.

Meanwhile, when using a cobalt (Co)- or iron (Fe)-containing catalyst precursor, the reactor may be warmed preferably to a temperature of 25-400° C., more preferably 100-350° C., and even more preferably 250-300° C. to deposit a single-atom catalyst. Herein, when the temperature of the reactor is lower than the lower limit temperature, 25° C., the vapor-phase cobalt (Co) or iron (Fe)-containing catalyst precursor cannot be deposited sufficiently on the surface of a support.

Although the temperature of the reactor was described above with reference to the use of a nickel (Ni)-, cobalt (Co)- or iron (Fe)-containing catalyst precursor, it is apparent to those skilled in the art that when using a catalyst precursor containing any metal other than the above-mentioned metals, the temperature of the reactor may be varied to a condition suitable for the deposition of the catalyst precursor on the support.

Then, after the warming is completed in steps (a-1) and (a-2), a path through which the vaporizer is linked with the reactor is opened to vaporize the catalyst precursor and to carry out chemical vapor deposition on the catalyst support in the reactor (a-3).

The catalyst precursor may further supply oxygen (O₂) or hydrogen (H₂) gas as a reactant gas accelerating the deposition on the surface of the catalyst support.

In addition, an inert gas may be further supplied to control the chemical vapor deposition rate.

It is possible to synthesize catalysts having a different dispersion degree, size and loading amount, depending on the temperature of the vaporizer and reactor, type of the carrier gas for transporting the catalyst precursor, type of a gas allowed to flow in the reactor additionally, or the like.

The carrier gas may be a reactive and/or non-reactive gas.

For example, when using hydrogen gas (H₂) as a carrier gas, chemical reaction, such as reduction or hydrogenation of the catalyst precursor, may occur, while the catalyst precursor is transported. However, such chemical reaction may vary depending on the temperature of the linking line by which the vaporizer is linked with the reactor. In general, the higher the temperature, the more active the reaction tends to be. Meanwhile, when using oxygen as a carrier gas, oxidation of the precursor may occur while the catalyst precursor is transported through the linking line. In addition, a hydrocarbon gas, such as methane, acetylene or ethanol, which may be used for the synthesis of carbon nanotubes, may be used as a carrier gas. However, such a hydrocarbon gas requires caution since it may induce the deposition of the precursor inside of the linking line, or the like, before arriving at the surface of the support on which the catalyst is to be deposited, or may cause contamination or deterioration of the precursor. In addition, not only a single type of gas but also various mixed gases having a different composition may be used as a carrier gas. For example, oxygen and nitrogen, oxygen and argon, oxygen and helium, hydrogen and nitrogen, hydrogen and argon, or hydrogen and helium may be mixed and used at a predetermined ratio.

After completing the preparation of the single-atom catalyst or the atomic cluster catalyst, carbon nanotubes are grown on the single-atom catalyst or the atomic cluster catalyst to obtain single-walled carbon nanotubes (SWCNTs) (step b).

First, the single-atom catalyst or the atomic cluster catalyst is disposed in a reactor and reduction is carried out (step b-1).

The reduction may be carried out by supplying hydrogen gas and an inert gas.

Herein, hydrogen gas may be used in an amount of 1-7 vol %, preferably 3-5 vol %, in the mixed gas of hydrogen gas with the inert gas.

The reduction may be carried out at 300-500° C. The reduction can be performed even at 500° C. or lower by virtue of the high activity of the catalyst including a single-atom and an atomic cluster.

After the reduction, the same atmosphere and temperature are retained for 3-5 hours so that the single-atom catalyst or the atomic cluster catalyst may be retained in a metallic state.

After that, an inert gas is supplied to the reactor, the reactor is warmed to 700-1000° C., and a hydrocarbon gas is introduced to grow single-walled carbon nanotubes (step b-2).

The hydrocarbon gas may be any one selected from methane (CH₄), acetylene, ethylene, propane, methanol, ethanol, propanol, butanol, acetone, benzene, xylene, hexane, dimethyl ether, pyridine, ethyl acetate, diethyl ether, polyethylene glycol and dichloromethane, preferably methane (CH₄) gas.

The hydrocarbon gas is allowed to flow at a constant concentration preferably, and the shape and distribution of carbon nanotubes vary with the concentration of the carbon precursor gas.

Preferably, the hydrocarbon gas may be supplied preferably at a concentration of 1-10 vol %, more preferably 1-5 vol %. When the flow rate is more than the upper limit, an excessively high concentration of hydrocarbon gas is in contact with the catalyst surface, and thus there is a problem in that merely a small fraction of hydrocarbon gas is used for the synthesis of carbon nanotubes and the remaining hydrocarbon gas cannot be used. In addition, in this case, it is not possible to retain the minimum time during which the hydrocarbon gas is in contact with the catalyst surface and single-walled carbon nanotubes are synthesized due to a high flow rate, which inhibits formation of single-walled carbon nanotubes. On the contrary, when the flow rate of the reactant gas is less than the lower limit, the reactant gas retains inside of the reactor for an excessively long time, and thus there is a problem in that a desired level of concentration of hydrocarbon for the synthesis of single-walled carbon nanotubes cannot be accomplished and the distribution of the produced single-walled carbon nanotubes is dilute, and single-walled carbon nanotubes or carbon fibers are produced not in a smooth linear shape but in a spiral, coiled, zigzag, donut-like shape, or the like.

Meanwhile, it is possible to remove the amorphous carbon impurities in the reactor or to improve the crystallinity of the carbon nanotubes by adding hydrogen gas at 0.1-5 vol %, or oxygen gas at 0.001-1 vol % to the reactor.

The catalyst support may be a ceramic support, a carbonaceous support or a metal support.

The ceramic support may be any one type selected from ceramic monolith, ceramic honeycomb and ceramic powder.

The ceramic support may be any one material selected from alumina, silica, titania, zirconia, magnesia, silicon carbide, tungsten carbide and silicon nitride, and an alumina support may be used preferably.

The carbonaceous support may be any one selected from graphite, carbon black, acetylene black, denka black, ketjen black, activated carbon, mesoporous carbon, carbon nanotubes, carbon nanofibers, carbon nanohorns, carbon nanorings, carbon nanowires, pullerene and Super P. When using such a carbonaceous support, the utility of single-walled carbon nanotubes may be further increased.

The metal support may be any one type selected from a metal mat, a metal foam and a metal net.

The metal catalyst may include any one metal selected from nickel (Ni), cobalt (Co), iron (Fe), platinum (Pt), gold (Au), aluminum (Al), chromium (Cr), copper (Cu), magnesium (Mg), manganese (Mn), molybdenum (Mo), rhodium (Rh), silicon (Si), tantalum (Ta), titanium (Ti), tungsten (W), uranium (U), vanadium (V) and zirconium (Zr), preferably any one metal selected from nickel (Ni), cobalt (Co) and iron (Fe).

The method for preparing single-walled carbon nanotubes (SWCNTs) according to the present disclosure may be used for preparing single-walled carbon nanotubes (SWCNTs) having a sectional diameter of 0.3-3 nm.

Particularly, when single-walled carbon nanotubes (SWCNTs) are prepared by using a single-atom catalyst, single-walled carbon nanotubes having a sectional diameter of less than 1 nm are prepared effectively. Since the atomic diameter of nickel (Ni), cobalt (Co), iron (Fe), or the like, is about 0.3-0.5 nm, it seems that single-walled carbon nanotubes having a sectional diameter of 0.3-3 nm, preferably 0.3-1.5 nm may be prepared advantageously.

In addition, when single-walled carbon nanotubes (SWCNTs) are prepared by using an atomic cluster catalyst, single-walled carbon nanotubes having a sectional diameter of 1-3 nm are prepared preferably, and single-walled carbon nanotubes having a sectional diameter of 1.5-3 nm are prepared more preferably.

Since the metal catalyst is deposited on the catalyst support in the form of a single atom or atomic cluster, it is possible to prepare single-walled carbon nanotubes having the above-defined range of sectional diameter.

The method for preparing single-walled carbon nanotubes (SWCNTs) may be used for preparing an electrode material for a secondary battery.

In the method for preparing single-walled carbon nanotubes (SWCNTs) according to the present disclosure, when the type of the catalyst support and that of the catalyst precursor in step (a), and the temperature of the reactor and the atmospheric condition in the reactor in step (b) satisfy all of the following conditions, it is possible to obtain a high production yield and to prepare single-walled carbon nanotubes having a uniform shape:
the catalyst support is —Al₂O₃ and the catalyst precursor is nickel(II) bis(2,2,6,6-tetramethyl-3,5-heptanedionate), in step (a)
the temperature of the reactor is 250-350° C. and the atmospheric condition in the reactor is a mixed hydrogen+argon gas containing 3-5 vol % of hydrogen gas, in step (b)

In another aspect of the present disclosure, there are provided single-walled carbon nanotubes (SWCNTs) prepared by the method for preparing single-walled carbon nanotubes (SWCNTs) according to the present disclosure.

The single-walled carbon nanotubes (SWCNTs) are characterized by a sectional diameter of 0.5-3 nm.

In still another aspect, there is provided an electrode for a secondary battery including the single-walled carbon nanotubes (SWCNTs) prepared by the method for preparing single-walled carbon nanotubes (SWCNTs) according to the present disclosure.

Hereinafter, preferred embodiments of the present disclosure will be explained.

### EXAMPLES

### Example 1: Preparation of Single-Walled Carbon Nanotubes Using Single-Atom Catalyst

### (1) Synthesis of Nickel Single-Atom Catalyst

To prepare a nickel single-atom catalyst, 0.1 g of Ni(TMHD)₂ was introduced to a vaporizer cut off from outside air, nitrogen gas was allowed to flow in the vaporizer at 50 sccm for 30 minutes or more to remove impurities, and the vaporizer was warmed to 190° C. at a rate of 5° C./min.

Meanwhile, 5 g of —Al₂O₃(Sigma Aldrich, Neutral, BET surface area 160 m²/g, pore volume 0.25 cm³/g) used as a catalyst support was introduced into a reactor made of quartz, nitrogen gas was allowed to flow in the reactor at 100 sccm for 30 minutes or more to remove impurities, and the reactor was warmed to 210° C. at a rate of 10° C./min to carry out chemical vapor deposition.

Herein, the time at which point the temperature of the vaporizer reaches 190° C. and the time at which point the temperature of the reactor reaches 210° C. were set equal, and the path through which the vaporizer is linked with the reactor was opened at the point where the corresponding temperature is reached, thereby controlling the deposition time and deposition degree accurately. When the nickel precursor in the vaporizer was totally vaporized and transported to the reactor with the progress of chemical vapor deposition, i.e. after the lapse of 30 minutes, the linking line between the vaporizer and the reactor was interrupted, and nitrogen gas was allowed to flow through the vaporizer and the reactor at a rate of 50 sccm and 100 sccm, respectively, while the vaporizer and the reactor were cooled to room temperature.

### (2) Synthesis of Single-Walled Carbon Nanotubes Using Single-Atom Catalyst

After the nickel single-atom catalyst prepared according to (1) was disposed in a reactor, reduction was carried out under hydrogen atmosphere so that the composition of nickel catalyst might retain a metallic state. In other words, while 5 vol % hydrogen/argon gas was allowed to flow in the reactor having the nickel single-atom catalyst disposed therein at a rate of 30 sccm, the reactor was warmed from room temperature to 500° C. at a rate of 10° C./min, and then the reactor was allowed to stand at the corresponding temperature for 4 hours so that nickel might be retained in a metallic state.

Then, while argon as an inert gas was allowed to flow in the reactor having the reduced metal-state catalyst disposed therein at a rate of 50 sccm, the reactor was warmed to 800° C. for the purpose of the synthesis of single-walled carbon nanotubes. When the temperature of the reactor reached 800° C., methane (CH₄) as a reactant gas was further introduced at a flow rate of 5 sccm to start the synthesis of carbon nanotubes. The synthesis time may vary with the shape and distribution of carbon nanotubes to be synthesized. In this Example, the synthesis was carried out for 30 minutes.

### Example 2: Preparation of Single-Walled Carbon Nanotubes Using Atomic Cluster Catalyst

### (1) Synthesis of Nickel Atomic Cluster Catalyst

A nickel atomic cluster catalyst was synthesized in the same manner as (1) of Example 1, except that the reactor was not retained at 210° C. but warmed to 250° C. to prepare an atomic cluster catalyst.

### (2) Synthesis of Single-Walled Carbon Nanotubes Using Nickel Atomic Cluster Catalyst

Single-walled carbon nanotubes were synthesized by using the nickel atomic cluster catalyst under the same condition as (2) of Example 1.

### Comparative Example: Preparation of Carbon Nanotubes Using Nickel Nanoparticles Prepared by Solution Method

### (1) Preparation of Nickel Catalyst Nanoparticles

A nickel nanocatalyst was deposited on the surface of a porous ceramic support by using a conventional method, initial impregnation method, used frequently for preparing a conventional nanocatalyst, and the resultant nickel nanoparticles were used as seeds to prepare carbon nanotubes. The method will be explained in detail hereinafter.

First, —Al₂O₃(Sigma Aldrich, Neutral, BET surface area 160 m²/g, pore volume 0.25 cm³/g) was used as a porous ceramic support and stored in an oven maintaining 100° C. or higher before the deposition of nickel to remove water completely. Nickel nitrate hexahydrate (Ni(NO₃)₂6H₂O, molecular weight 290.79) was used as a catalyst precursor for the deposition of nickel nanoparticles and was dissolved in distilled water corresponding to the volume of the pores of the support to prepare a precursor solution. Then, —Al₂O₃ powder was introduced to a dried crucible, the precursor solution containing the catalyst precursor dissolved therein was introduced thereto in a small amount by using a dropping pipette and dispersed by using a glass rod so that the catalyst precursor solution might be introduced into the pores of —Al₂O₃. After the catalyst precursor solution was totally mixed with —Al₂O₃ powder, the resultant mixture was dried at room temperature for 12 hours or more to remove the solvent ingredient, and then further dried in an oven at 110° C. for 12 hours or more so that any solvent ingredient that might remain in the pores might be removed completely. After the completion of the drying, the nickel catalyst was introduced to a heating furnace and baked in the air at 450° C. for 4 hours so that the functional groups bound to nickel might be totally decomposed and dispersed on the surface of —Al₂O₃ in the form of nanocrystals of nickel oxide phase.

### (2) Preparation of Carbon Nanotubes

Carbon nanotubes were prepared in the same manner as Example 1, except that the nickel nanoparticle catalyst prepared according to the above-described solution method was used.

### TEST EXAMPLES

### Test Example 1: Determination of Change in Weight of Nickel Catalyst Precursor Depending on Temperature

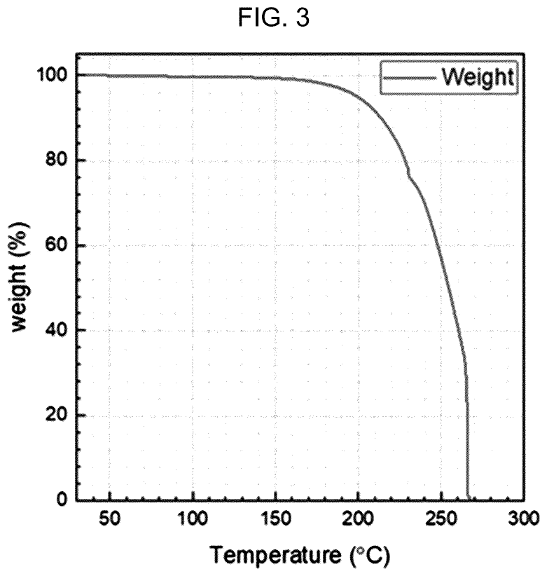

To determine a change in weight of the nickel catalyst precursor, Ni(TMHD)₂, used in Example 1 depending on temperature under nitrogen atmosphere, thermogravimetric analysis (TGA) was carried out. The results are shown in FIG. 3.

After the analysis, it can be seen that the nickel catalyst precursor, Ni(TMHD)₂ starts to be decomposed at about 150° C. and is completely decomposed at about 270° C. In other words, when the vaporization temperature is low, the vaporization rate is also low. Therefore, this can be used when the vaporization rate is to be reduced intentionally. It can be also seen that when the vaporization temperature is high, the vaporization rate is high, but the particle size is increased or there is a disadvantage in controlling the precise deposition behavior.

### Test Example 2: Electron Microscopic Image Analysis of Deposited Catalyst

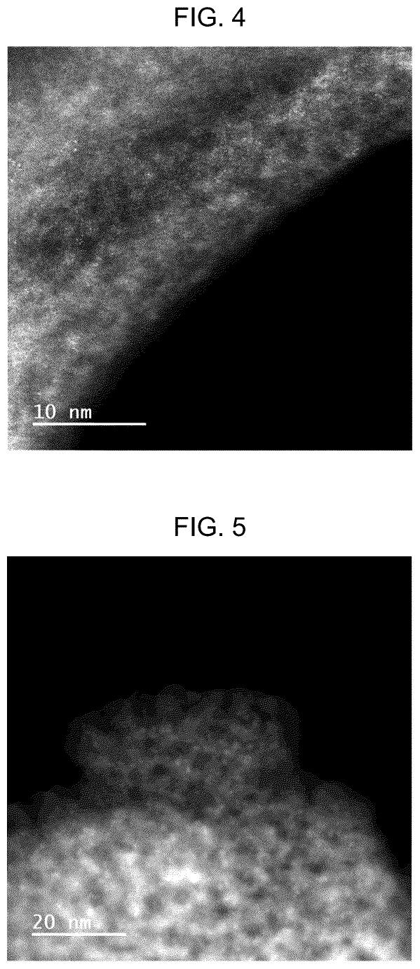

FIG. 4 shows an electron microscopic image of the single-atom nickel catalyst deposited on an alumina support, prepared according to (1) of Example 1, and FIG. 5 shows an electron microscopic image of the nickel atom cluster catalyst prepared according to (1) of Example 2.

Referring to FIG. 4, it can be seen that the single-atom type nickel catalyst deposited on amorphous alumina (—Al₂O₃) according to (1) of Example 1 of the present disclosure is deposited with a significantly smaller size as compared to the catalyst deposited according to the related art, and thus is significantly effective for preparing single-walled carbon nanotubes having a diameter of less than 1 nm and is significantly favorable to preparing single-walled carbon nanotubes having a diameter of 0.3-1 nm, which is slightly larger than the diameter of nickel atom.

In addition, referring to FIG. 5, it can be seen that the atomic cluster type nickel catalyst deposited on amorphous alumina (—Al₂O₃) according to (1) of Example 2 of the present disclosure is deposited with a significantly smaller size as compared to the catalyst deposited according to the related art and has a slightly larger size as compared to the single-atom type nickel catalyst. It can be also seen that such an atomic cluster type catalyst is effective for preparing single-walled carbon nanotubes having a diameter of about 1-3 nm, which is slightly larger diameter as compared to the embodiment using the nickel single-atom type catalyst.

### Test Example 3: Electron Microscopic Image Analysis of Single-Walled Carbon Nanotubes (SWCNTs)

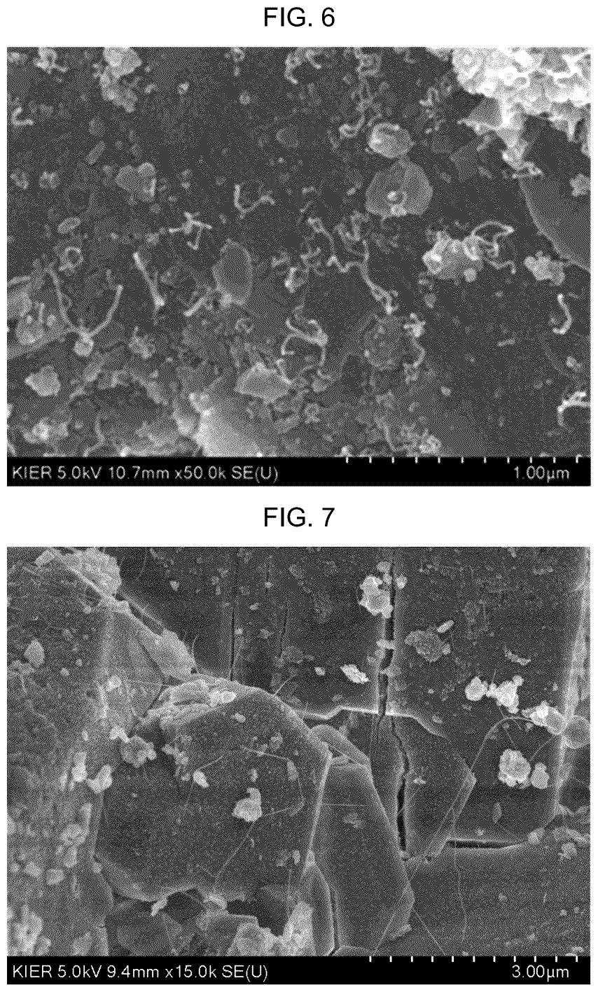

FIG. 6 is an electron microscopic image illustrating the single-walled carbon nanotubes (SWCNTs) prepared according to Example 1, and FIG. 7 is an electron microscopic image illustrating the single-walled carbon nanotubes (SWCNTs) prepared according to Comparative Example 1.

After the analysis, it can be seen that single-walled carbon nanotubes (SWCNTs) are grown in a linear shape on the surface of alumina (—Al₂O₃) containing a nano-scaled nickel catalyst dispersed therein by the initial impregnation method according to Comparative Example 1 and have a sectional diameter of 5-8 nm. On the contrary, the single-walled carbon nanotubes (SWCNTs) prepared according to Example 1 have a sectional diameter of 3 nm or less, which is significantly reduced as compared to the single-walled carbon nanotubes (SWCNTs) according to Comparative Example 1, since the nano-scaled nickel catalyst is substituted with the nickel single-atom catalyst. In addition, single-walled carbon nanotubes (SWCNTs) having a sectional diameter of less than 1 nm are also observed.

### Test Example 4: ICP-OES Analysis for Determination of Nickel Loading Amount

To determine the nickel loading amount of the nickel single-atom catalyst prepared according to (1) of Example 1 and that of the nickel nanoparticle catalyst prepared according to (1) of Comparative Example 1, inductively coupled plasma-optical emission spectrometry (ICP-OEP) analysis was carried out. The results are shown in the following Table 1.

TABLE 1

| | Nickel single-atom | Nickel nanoparticle |
|---|---|---|
| | catalyst according | catalyst according to |
| | to (1) of Example 1 | (1) of Comparative Example 1 |
| Ni loading | 0.6 wt % | 5.0 wt % |
| amount (wt %) | | |

It can be seen that the nickel single-atom catalyst prepared according to (1) of Example 1 has a nickel loading amount of 0.6 wt %, and the nickel nanoparticle catalyst prepared according to (1) of Comparative Example 1 has a nickel loading amount of 5.0 wt %.

### Test Example 5: X-Ray Diffractometry (XRD) Analysis

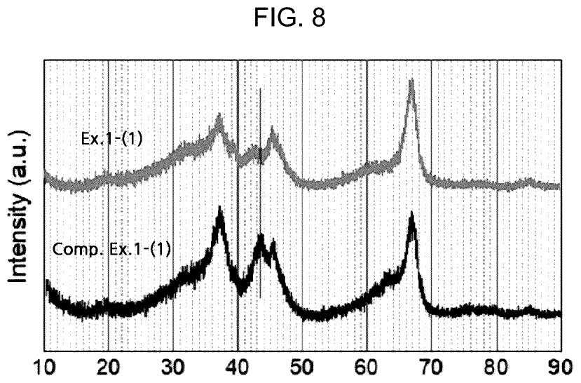

The nickel single-atom catalyst prepared according to (1) of Example 1 and the nickel nanoparticle catalyst prepared according to (1) of Comparative Example 1 were analyzed by X-ray diffractometry. The results are shown in FIG. 8.

It can be seen that a peak corresponding to nickel oxide (NiO) derived from nickel particles clearly appear at 43.2° in the case of the nickel nanoparticle catalyst according to Comparative Example 1. On the contrary, any peak of crystalline particles is not observed at the corresponding position in the case of the nickel single-atom catalyst according to Example 1. In other words, in the case of the nickel single-atom catalyst, no peak corresponding to crystalline nickel particles appears, even though 0.6 wt % of nickel is deposited in the nickel single-atom catalyst. This demonstrates that the nickel single-atom catalyst prepared according to (1) of Example 1 of the present disclosure has a significantly small particle size.

The present disclosure has been described in detail with reference to specific embodiments. However, it will be apparent that various changes and modifications could be made to the present disclosure by those skilled in the art through the addition, change, elimination, supplement, or the like, without departing from the scope of the present disclosure, and such changes and modifications are also included in the scope of the present disclosure.

What is claimed is:

1. A method for preparing single-walled carbon nanotubes (SWCNTs), comprising the steps of:
(a) depositing a metal catalyst in the form of single atom or atomic cluster on a catalyst support to prepare a single-atom catalyst or an atomic cluster catalyst; and
(b) growing carbon nanotubes on the single-atom catalyst or the atomic cluster catalyst to prepare single-walled carbon nanotubes (SWCNTs).

2. The method for preparing single-walled carbon nanotubes (SWCNTs) according to claim 1, wherein step (a) comprises the steps of:
(a-1) introducing a catalyst precursor to a vaporizer cut off from outside air, supplying an inert gas thereto and warming the vaporizer;
(a-2) introducing a catalyst support to a reactor, supplying an inert gas thereto and warming the reactor; and
(a-3) opening a path through which the vaporizer is linked with the reactor after completing the warming in steps (a-1) and (a-2) to vaporize the catalyst precursor and to carry out chemical vapor deposition on the catalyst support in the reactor.

3. The method for preparing single-walled carbon nanotubes (SWCNTs) according to claim 2, wherein the catalyst precursor in step (a-1) is a catalyst precursor comprising any one selected from nickel (Ni), cobalt (Co), iron (Fe), platinum (Pt), gold (Au), aluminum (Al), chromium (Cr), copper (Cu), magnesium (Mg), manganese (Mn), molybdenum (Mo), rhodium (Rh), silicon (Si), tantalum (Ta), titanium (Ti), tungsten (W), uranium (U), vanadium (V) and zirconium (Zr).

4. The method for preparing single-walled carbon nanotubes (SWCNTs) according to claim 3, wherein the catalyst precursor in step (a-2) is a nickel (Ni)-containing catalyst precursor, and the reactor is warmed to a temperature of 150-500° C.

5. The method for preparing single-walled carbon nanotubes (SWCNTs) according to claim 2, wherein the catalyst support in step (a-3) further supplies oxygen (O₂) or hydrogen (H₂) gas as a reactant gas accelerating the deposition on the surface of the catalyst support.

6. The method for preparing single-walled carbon nanotubes (SWCNTs) according to claim 2, wherein step (b) comprises the steps of:
(b-1) disposing the single-atom catalyst or the atomic cluster catalyst in the reactor and carrying out reduction of the catalyst; and
(b-2) supplying an inert gas to the reactor, warming the reactor to 700-1000° C., and introducing a hydrocarbon gas to grow single-walled carbon nanotubes (SWCNTs).

7. The method for preparing single-walled carbon nanotubes (SWCNTs) according to claim 6, wherein the reduction in step (b-1) is carried out by supplying hydrogen gas and an inert gas.

8. The method for preparing single-walled carbon nanotubes (SWCNTs) according to claim 6, wherein the reduction in step (b-1) is carried out at 300-500° C.

9. The method for preparing single-walled carbon nanotubes (SWCNTs) according to claim 6, wherein the hydrocarbon gas in step (b-2) is any one selected from methane (CH₄), acetylene, ethylene, propane, methanol, ethanol, propanol, butanol, acetone, benzene, xylene, hexane, dimethyl ether, pyridine, ethyl acetate, diethyl ether, polyethylene glycol and dichloromethane.

10. The method for preparing single-walled carbon nanotubes (SWCNTs) according to claim 6, wherein the hydrocarbon gas in step (b-2) is supplied at a concentration of 1-10 vol %.

11. The method for preparing single-walled carbon nanotubes (SWCNTs) according to claim 1, wherein the catalyst support is any one selected from a ceramic support, a carbonaceous support and a metal support.

12. The method for preparing single-walled carbon nanotubes (SWCNTs) according to claim 11, wherein the ceramic support is any one selected from alumina, silica, titania, zirconia, magnesia, silicon carbide, tungsten carbide and silicon nitride.

13. The method for preparing single-walled carbon nanotubes (SWCNTs) according to claim 11, wherein the carbonaceous support is any one selected from graphite, carbon black, acetylene black, denka black, ketjen black, activated carbon, mesoporous carbon, carbon nanotubes, carbon nanofibers, carbon nanohorns, carbon nanorings, carbon nanowires, pullerene and Super P.

14. The method for preparing single-walled carbon nanotubes (SWCNTs) according to claim 1, which is for preparing single-walled carbon nanotubes (SWCNTs) having a sectional diameter of 0.3-3 nm.

15. The method for preparing single-walled carbon nanotubes (SWCNTs) according to claim 14, which is for preparing single-walled carbon nanotubes (SWCNTs) having a sectional diameter of 0.3-1.5 nm by using a single-atom catalyst.

16. The method for preparing single-walled carbon nanotubes (SWCNTs) according to claim 14, which is for preparing single-walled carbon nanotubes (SWCNTs) having a sectional diameter of 1.5-3 nm by using an atomic cluster catalyst.

17. Single-walled carbon nanotubes (SWCNTs) prepared by the method as defined in claim 1.

18. An electrode for a secondary battery comprising the single-walled carbon nanotubes (SWCNTs) as defined in claim 17.
